(19) United States
(12) Patent Application Publication
(10) Pub. No.: US 2002/0108585 A1
(43) Pub. Date: Aug. 15, 2002

(54) Transport for propane cannon

(76) Inventor: Ed Davis, Bakersfield, CA (US)

Correspondence Address: STETINA BRUNDA GARRED & BRUCKER, 75 ENTERPRISE, SUITE 250, ALISO VIEJO, CA, 92656, US

(21) Appl. No.: 09/781,355

(22) Filed: Feb. 12, 2001

(51) Int. Cl. A01M 15/00

(52) U.S. Cl. 119/712

(57) ABSTRACT

A transport for selectively positioning a propane gun at specified sites about an area of land. According to a preferred embodiment, a transport comprises a wheeled carriage having a platform or mount formed thereon for receiving and securably holding a propane cannon with source of propane coupled therewith. Preferably, the propane canon with propane source will be rotationally mounted upon the carriage to thus enable the cannon to be fired in select directions. The carriage may further be provided with a motorized drive mechanism, such as by a small horse power, four-cycled gas engine, to thus enable a propane cannon to be rapidly and easily transported to a desired site. The carriage is further configured such that the propane cannon can withstand repeated firings of the propane cannon, as well as absorb the recoil imparted thereby. The carriage may further preferably be formed such that the tires thereof may be mounted upon a track or otherwise disposed within a formed trench to enable the same to automatically move along a desired pathway.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present application is directed to novel systems and methods for deterring birds and other nuisance wildlife. More specifically, such application is directed to mechanisms and techniques for mobilizing propane cannons to thus enable the same to be easily and readily deployed over a greater area than conventional propane canyons currently in use.

By way of background, propane canyons are widely used both domestically and abroad as a scare mechanism to drive problem wildlife away from a given area. Such guns are particularly useful in deterring problem wildlife from agricultural fields, orchards and airports, as well as anywhere else birds and animals are not wanted. The most widely utilized and well-known of such propane cannons is known as the Zon Gun, produced by the Zon Corporation of Holland, which come in a variety of sizes and produce explosions of varying degrees of loudness as may be necessary for a given application. In all such models, however, there is generally provided a portable propane-fired cannon operative to emit automatic thunderclaps at selectively adjusted intervals. Typically, such detonation can be adjusted from two to thirty minutes. Such propane cannons operate on liquid propane gas, and utilize a lighter mechanism to generate a spark which, in turn generates the thunder clap explosion.

Problematic with virtually all propane cannons, and in particular the Zon Gun product line of propane cannons, is the fact that all are ground-mounted. In this regard, given the repeated explosions emanating from the gun at frequent intervals, such device is specifically designed for stationary positioning. Among the drawbacks with the stationary ground-mounted configuration, however, is the fact that over time birds and other nuisance wildlife become habituated to the repetitious explosions produced by such guns, as well as the point at which such explosion emanate. Indeed, over time, the unwanted wild life will eventually redistribute geographically about the propane cannon and thereafter continue to create the nuisance, but only in a different local. While propane cannons such as the Zon Guns are produced which have rotating double guns or rotating single guns to thus enable detonations to be made in varying direction, nuisance birds and animals still can eventually become habituated to such explosions given the fact that the explosions emanate from one ground-based local. Unfortunately, due to the ground-based nature of propane cannons, in order to effectively eradicate birds and pests necessarily requires that such cannon be physically moved on a periodic basis at various points in a given about the area from which the pests are to be driven. Alternatively, multiple propane cannons can be utilized and placed at select positions about the area from which the pests are to be driven such that explosions can be generated at multiple points to thus cooperatively drive the pests from the given area.

Each of the aforementioned approaches, however, has been shown to be expensive, time consuming and not optimally effective. Firstly, to randomly move a Zon Cannon from one ground based location to another requires considerable labor. Moreover, such approach, in order to be effective, necessarily requires that the propane cannons be re-positioned on a periodic basis insofar as animals and birds can and frequently do become habituated to the placement of the propane cannon after a short amount of time. The alternative technique to use multiple Zon Cannons is exceedingly expensive and possibly ineffective insofar as animals and birds can ultimately inhabit areas about the permanently-mounted Zon Guns once the wildlife adjust to and become accustomed to the positions at which the propane cannons are located.

Accordingly, there is a substantial need in the art for a mechanism by which a single propane cannon, and in particular the Zon Gun brand of propane cannons can be utilized to deter unwanted birds and other wildlife from the broadest geographic area possible that is more effective, efficient and less costly than other prior art systems and techniques. There is a further need in the art for such systems and methods that are exceedingly simple to use, of simple construction, inexpensive to operate, and can be readily integrated into current land use schemes, and in particular airports and agricultural plots. There is still further need in the art for such systems and techniques that can be readily incorporated with conventional propane cannons that does not require any alternation or modification thereof, is not harmful to the environment, and is operative to only facilitate scaring unwanted birds and wildlife (as opposed to effecting the morbidity and mortality thereof).

### BRIEF SUMMARY OF THE INVENTION

The present invention specifically addresses and alleviates the above-identified deficiencies in the art. In this regard, the present invention is directed to a propane cannon transport which enables a propane cannon to be easily and quickly positioned at various points about a given field or area of land. According to a preferred embodiment, the transport comprises a carriage having a mount or platform formed thereon for receiving and securably holding a propane cannon, as well as propane source coupled therewith. The propane cannon with propane tank are further preferably rotationally mounted upon the carriage to thus enable the cannon to be fired in a desired direction. Although any of a variety of structures formed from any of a variety of materials may utilized to fabricate the carriage, it is currently contemplated that one and a quarter (1¼) inch to one and a half (1½) inch metal tubing will provide sufficient durability to support the propane cannon, as well as withstand the recoil of such propane cannon as the same as repeatedly fired. To facilitate movement of the carriage, such carriage will preferably be supported by at least one, and preferably four wheel members. In this respect, the preferred embodiment of the carriage will be configured to include first and second pairs of front and rear tires. The tires themselves may take any of a variety of configurations, although standard, heavy-duty twenty-six inch bicycle wheels, along with bicycle tires and inner tubes utilized therewith are preferred.

In more highly refined embodiments, the carriage will be motorized to thus enable the same to be rapidly transported. To that end, any of a variety of motors or engines may be utilized. Preferably, a small horse power four-cycle gas engine, such as those produced by Briggs and Straton of Milwaukee, Wis. and Honda Motor Corporation of Tokyo, Japan, which may be utilized to drive the carriage by any of a variety of mechanisms such as chains, belt drives, and the like. In one preferred embodiment, the gas engine may be coupled to a hydraulic drive system, namely, a hydraulic pump and hydraulic motor which are fluidly coupled to one, or preferably all of the wheels of the carriage to thus drive the same in a desired direction. To that end, the carriage may be further coupled with a transmission mechanism, such as a wand coupled to the hydraulic drive system, which enables a user to manually direct the carriage in forward, reverse or neutral. In automated applications, it is contemplated that the carriage may be either mounted upon a track or positioned such that one or more wheels of the carriage are disposed in elongate trench dug or otherwise formed in the ground, which thus dictates the direction of the carriage as the same moves backwards or forwards. In use, such trenches can be preferably be formed in a desired pattern about a given field to thus enable the carriage with propane cannon mounted thereon to be selectively positioned at any of a variety of desired locations thereabout to thus enable the cannon to be randomly deployed in a rapid and easy manner to thus prevent the undesired wildlife from becoming habituated to repetitious explosions of the propane cannon that would otherwise emanate from a single point.

It is therefore an object of the present invention to provide a propane cannon transport which easily and rapidly enables a propane cannon to be selectively deployed at any of a variety of points about a given area of land.

Another object of the present invention is to provide a propane cannon transport which is more efficient and effective in an eradicating birds and other unwanted wildlife than prior art ground-based propane cannons.

Another object of the present invention is to provide a transport for a propane cannon that can enable the propane cannon to be repeatedly deployed and still enable the same to be easily and readily transported to any of variety of points about a given area of land.

Another object of the present invention is to provide a transport for a propane cannon that, when utilized with a track or trench mechanism for guiding the wheels thereof, can enable the transport to be automatically positioned at any of a variety of sites about a given area of land.

Still further object of the present invention is to provide a transport for a propane cannon that is of simple construction, is easy and inexpensive to manufacture, may be immediately deployed and utilized with existing propane guns, is easy to utilize, is fuel efficient, poses little, if any, threat to the environment and provides an exceptionally safe and humane mechanism for deterring unwanted birds in wildlife from inhabiting a specified area.

### BRIEF DESCRIPTION OF THE DRAWINGS

These, as well as other features of the present invention, will become more apparent upon reference to the drawings wherein:

FIG. 1 is an elevated, perspective view of a propane cannon transport for mobilizing and selectively deploying a propane cannon with propane source coupled therewith about a given area of land, a transport being constructed in accordance with a preferred embodiment of the present invention.

FIG. 2 is an elevated, perspective view of a rotational propane cannon mount for securing and rotationally holding a propane cannon with propane source utilized therewith with the transport depicted in FIG. 1.

FIG. 3 is a top view of the transport of the present invention with propane cannon mounted thereon depicting the ability of the latter to be deployed about 360° as the transport moves backward or forward along a defined pathway.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

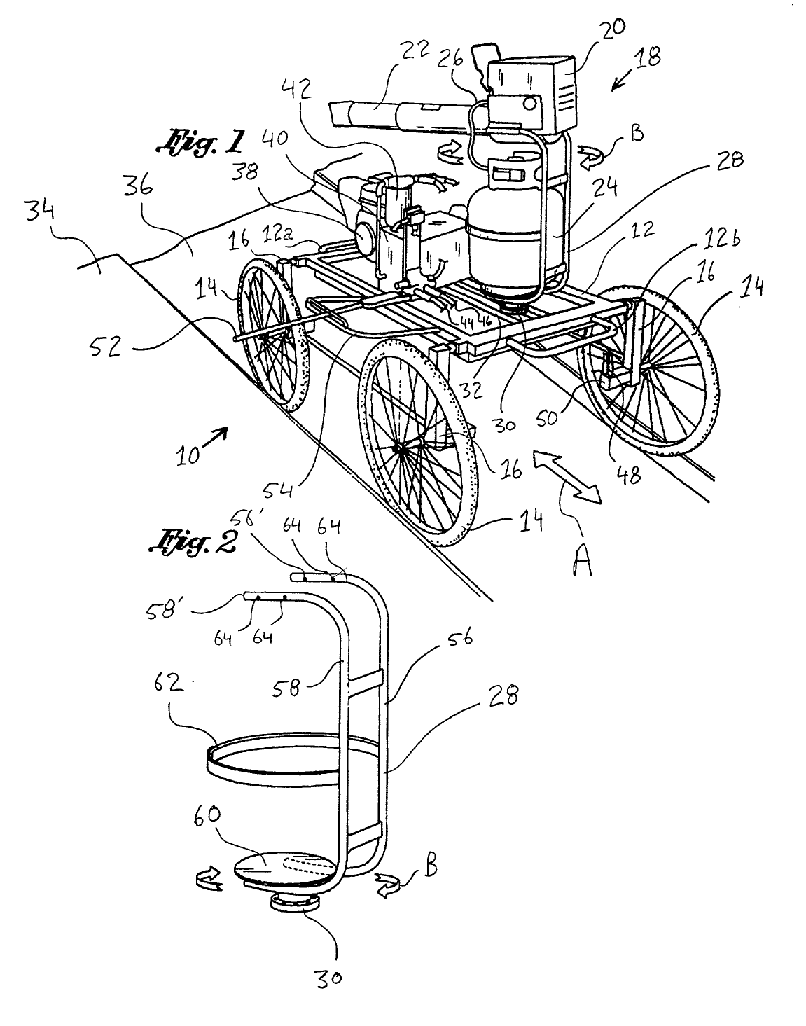

Referring now to the figures, and initially to FIG. 1, there is perspectively illustrated a transport 10 for immobilizing and selectively placing a propane cannon system 18 at select places about a specified area of land. In this regard, the transport 10 is operative to deploy the propane cannon system 18 at any of a variety of selectively-chosen sites about a given area of land to thus enable the propane cannon to provide more random and varied thunderclaps thereabout to thus prevent unwanted wildlife from becoming habituated to a particular location at which such cannon is fired.

As shown, the transport 10 comprises a carriage 12 defining an upper platform surface upon which the propane cannon system 18, as well as other preferred items are mounted, as will be discussed more fully below. The carriage 12 is supported by at least one, and preferably four wheels 14 disposed about the carriage 12. In the preferred embodiment, the carriage 12 is provided with four wheels 14 arranged as front and rear pairs of wheels, as shown, with each wheel 14 being interconnected to the carriage 12 via a dedicated wheel support member 16. As will be appreciated, in the arrangement shown the carriage 12 is operative to move forward and backward, as indicated by the letter A.

The carriage 12 and wheels 14 supporting the same may take any of a variety of forms well-known to those skilled in the art. Among the preferred configurations, such carriage 12 will be formed from one and a quarter (1¼) inch to one and a half (1½) inch metal tubing. The wheels may take the form of conventional bicycle wheels and tires. In one preferred embodiment, standard, heavy-duty twenty-six (26) inch bicycle wheels, tires and tubes, typically utilized with mountain bikes, are exceptionally ideal for use in rough or uneven terrain, as may be encountered in agricultural applications.

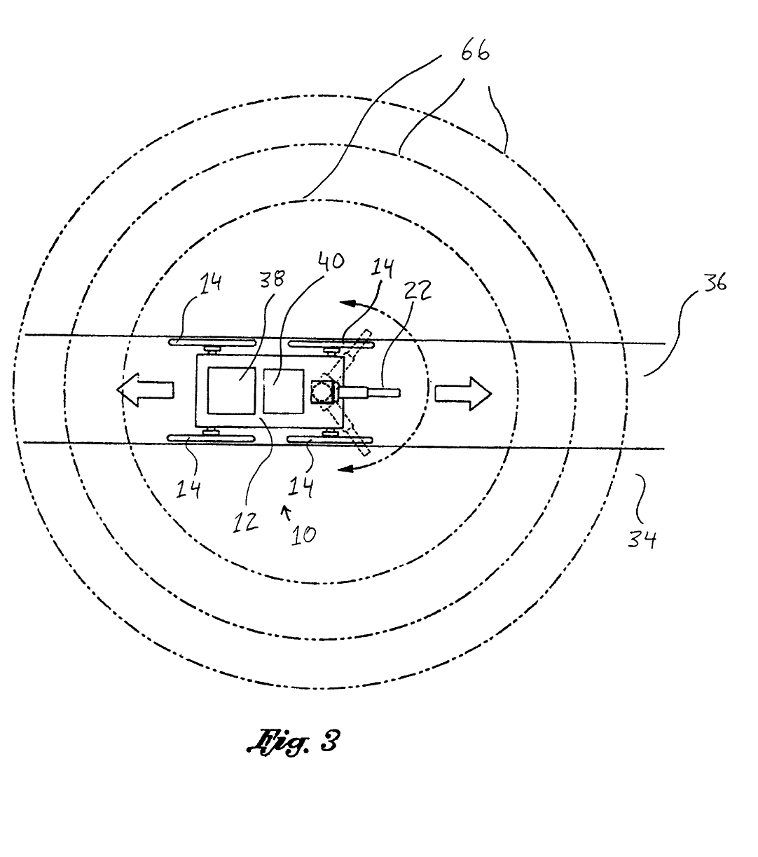

Mounted upon the carriage 12 is the propane cannon system 18, as shown. As is well-known to those skilled in the art, such a system 18 comprises the combination of a lighter/firing mechanism 20 coupled with a barrel member 22 from which the explosions emanate. As is further well-known, such system 18 further includes a propane source 24 fluidly coupled via tubing 26 to the firing mechanism 20 and barrel 22 to thus enable the system 18 to be repetitiously fired as desired. The propane cannon system 18 is preferably mounted upon the carriage via a propane cannon support 28, more clearly depicted in FIG. 2. As illustrated therein, support 28 comprises first and second elongate support members 56, 58 that are preferably arranged in generally parallel relation to one another. The members 56, 58 are bent at the distal-most ends thereof 56′, 58′, the latter of which having holes 64 formed thereon to provide a mounting mechanism upon which the propane cannon can be affixed. There is further formed upon support 28 a propane tank holder member 62, which is specifically adapted and designed to hold a propane tank, as illustrated in FIG. 1. At the base of the support 28 is a support plate 60, which provides a surface upon which the propane tank 24 can rest. Such support plate 60 is rotationally mounted on mount 30, the latter of which is rigidly affixed to support beams 32 formed upon the carriage 12, as shown in FIG. 1. According to a preferred embodiment, support plate 60 with members 56, 58 extending upwardly therefrom are rotationally mounted upon mount 30, similar to a “lazy susan”, to thus enable the same to rotate freely thereabout, as indicated by the direction B. In this regard, it is desired that such support 28 be operative to freely rotate about mount 30 to thus enable the propane cannon system 18 and more particularly the barrel 22 thereof, to be aimed at a desired direction, discussed more fully below.

In order to facilitate the ability of the transport 10 to be mobilized in the direction indicated by the letter A, the carriage 12 has utility bars 12a, 12b formed thereon, which can enable the transport 10 to be pulled in a desired location. Such utility bars 12a, 12b further facilitate the ability to handle the device.

In the preferred embodiment shown, however, the transport 10 will preferably be provided with driving means to enable the same to be self-propelled. To achieve that end, there is preferably provided an engine 38 which is operative to drive one or more of the wheels 14. In this regard, it is contemplated that such engine 38 may take any of a variety of engines well-known in the art and may comprise any type of engine, that is, either gasoline or electrically powered (either battery or alternating current). In a preferred embodiment, such engine 38 comprises a small, four-cycle gas engine, and may include any low-horsepower engines produced by Briggs and Straton of Milwaukee, Wis. or Honda Motor Corporation of Tokyo, Japan. In this respect, it is believed that an engine possessing approximately 5.5 horsepower can provide sufficient force to adequately mobilize the transport 10 with propane cannon system 18 mounted thereon.

As will further be recognized in the art, the engine 38 may be operative to drive the transport 10 via any of a variety of mechanisms, such as through chains, belt drives, or any means known or later developed in the art whereby the energy produced by the engine can be transmitted to the transport 10. In the embodiment shown, such engine 38 is operatively coupled to a hydraulic drive mechanism 40 which is operative to transmit hydraulic oil to one, and preferably all of the wheels 14 to thus cause the same to move in the desired direction. Such a drive system will thus include a hydraulic pump and motor that are operative to force hydraulic fluid to one or more of the wheels. To achieve that end, emanating from the hydraulic pump will be tubing, such as 44, 46 that are operative to force and collect fluid therethrough in a circulatory fashion. Such fluid will be transmitted via tubing, not shown, to at least one, and preferably all wheels via input and output ducts, such as 48, which, by virtue of creating a directional flow, cause an internally-disposed turbine or other like mechanism disposed within a housing 50 to impart rotational movement to the wheel. Such hydraulic fluid is continuously circulated throughout the system to thus enable continuous driving forces to be applied to one or more of the wheels 14. Among the suitable components for such embodiment include Parker-brand hydraulic pumps, such as Part Number PZG1A02751, Eaton-brand hydraulic motors such as Part Number 129-0020, in combination with Hydro-Force flow control, Part Number FR10-39-0-N with aluminum body Part Number 7024360. Such a system further incorporates a divider, among those preferred being Hydro-Force brand divider with body, Part Number FD10-40-0-N-11 with Part Number 7027000. Such products, however, are merely representative of a myriad of alternative products and designs which may be incorporated into the practice of the present invention.

To enable the transport 10 to be mobilized in the desired direction, there will further be provided a transmission mechanism, such as wand 52, to thus enable the 10 direction of the transport 10 to be selectively controlled such that the transport may either move in a forward or reverse direction, or remain in a neutral position. In the embodiment shown, such transmission wand 52 is operatively coupled to the fluid input and output ports 44, 46 to thus direct the direction by which such fluid is transmitted to the wheels.

To further facilitate the ability of the transport 10 to move along a given direction, it is contemplated that the transport 10 may be mounted upon a track or other type of guided pathway about a given area of land. As shown in FIG. 1, there may preferably be provided a trench 36 formed upon the ground 34 within which the wheels 14 of the transport 10 may be disposed. As will be readily appreciated by those skilled in the art, the trench 36 will define a pathway upon which the transport 10 will be mobilized. Although depicted as an elongate trench 36, it will be recognized that such trench 36 need only be wide enough to receive one pair of front and rear tires. In this respect, such trench 36 can operate as a track to thus enable the transport 10 to be moved automatically to any of a variety of points about a given area of land to thus enable the propane cannon system 18 to be deployed at such select points.

To that end, there is depicted in FIG. 3 the manner by which the transport may be deployed. As illustrated in such top view, the carriage 12 may be wheeled along pathway 36 formed upon ground 34 to a desired location. To achieve that end, motor 38 and hydraulic system 40 coupled therewith may be utilized to mobilize and facilitate the placement of the transport 10 at a desired location. The propane cannon, more particularly barrel 22 thereof, may be rotated in a desired direction to thus produce thunderclaps which will emanate at any of a variety of circular positions indicated by 66. Advantageously, due to the construction of the carriage 12 and the manner by which the same is supported by wheels 14, the transport 10 possesses sufficient durability to enable the propane cannon to be repeatedly fired thereon for an indefinite number of times. In this respect, the transport 10 is specifically configured to withstand the recoil generated from firing such cannon.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What I claim is as follows:

1. A transport for the mobile deployment of a propane cannon and propane source coupled therewith comprising a wheeled carriage having a support formed thereon for receiving and securably holding said propane cannon and source of propane utilized therewith, said carriage being operative to selectively transport said propane cannon and source of propane utilized therewith in support said cannon as said cannon is discharged.

2. The transport of claim 1 wherein said propane cannon is rotationally mounted upon said carriage.

3. The transport of claim 1 wherein said propane cannon and source of propane utilized therewith are both rotationally mounted upon said carriage.

4. The transport of claim 1 wherein said carriage is supported by four wheels disposed about said carriage.

5. The transport of claim 4 wherein said wheels are arranged as front and rear pairs of wheels.

6. The transport of claim 1 wherein said transport further comprises a motor for driving said wheels of said carriage.

7. The transport of claim 6 wherein said motor comprises a gasoline-powered engine.

8. The transport of claim 6 wherein said motor comprises an electrically-driven motor.

9. The transport of claim 8 wherein said motor is powered by an electricity source selected from the group consisting of a direct current or an alternating current.

10. A method for deterring birds and wildlife from an area of land comprising the steps:
a. providing a propane gun and propane source coupled therewith;
b. providing a transport for said propane cannon and said propane source coupled therewith, said transport comprising a wheeled carriage having a support formed thereon for receiving and securably holding said propane cannon and source of propane;
c. mobilizing and selectively positioning said propane cannon and propane source via said transport to a specified site within said area;
d. firing said propane cannon at least once at said specified site; and
e. repeating steps c and d.

11. The method of claim 10 wherein in step c, said propane cannon and propane source coupled therewith are transported via said transport along a predefined pathway.

12. The method of claim 11 wherein said pre-determined pathway is defined by a track.

13. The method of claim 11 wherein said pathway is defined by a trench.

14. The method of claim 10 wherein said specified area is selected from the group consisting of an airport, orchard, and agricultural crop.
